(19) United States
(12) Patent Application Publication
(10) Pub. No.: US 2017/0354154 A1
(43) Pub. Date: Dec. 14, 2017

(54) Repellent wrist or ankle band

(71) Applicant: Eduardo Guimarães KUBITSKI, Curitiba (BR)

(72) Inventor: Eduardo Guimarães KUBITSKI, Curitiba (BR)

(21) Appl. No.: 15/178,070

(22) Filed: Jun. 9, 2016

(51) Int. Cl. A01N 65/22; A41D 20/00; A01N 25/34

(52) U.S. Cl. CPC A01N 65/22; A01N 25/34; A41D 20/00

(57) ABSTRACT

The present invention relates to a wrist or ankle band that enables one to repel unpleasant pests, for example mosquitoes, flies, bees, bugs, and flying pests from the human body. Plant essential oils, chemical pest repellents and natural insect repellent ingredients, are impregnated in the constituent material of the wrist or ankle band so that by means of using said wrist or ankle band a person can avoid contact with those pests. The wrist or ankle band according to the present invention may provide that the layer of repellent is printed onto the wrist or ankle band material or is otherwise incorporated therein.

### FIELD OF THE INVENTION

The present invention relates to a wrist or ankle band that enables one to repel unpleasant pests, for example mosquitoes, flies, bees, bugs, and flying pests from the human body. Plant essential oils, chemical pest repellents and natural insect repellent ingredients, are impregnated in the constituent material of the wrist or ankle band so that by means of using said wrist or ankle band a person can avoid contact with those pests.

### BACKGROUND OF THE INVENTION

Repellent bearing wrist or ankle bands are well known in the art. Such wrist or ankle bands generally comprise a specific housing comprising a desired repellent so that the repellent is released upon contact with the body temperature or upon friction.

In recent years, in light of globalization and the intense flow of people around the world, an increasing opportunity to expose the human body to harmful insect pests has been noted. Such unpleasant pest approach may result in undesired mosquito bites, for example, which in turn can lead to allergic responses and exposure to insect transmitted diseases.

### SUMMARY OF THE INVENTION

The present invention provides an insect repellent wrist or ankle band, the wrist or ankle band having a layer of repellent arranged to be volatilized so as to protect the user.

The wrist or ankle band has the advantage that the repellent deposited may still be sensed by a user shortly after the wrist or ankle band has been removed.

In general, insects such as mosquitoes and flies or bees can cause a variety of diseases and causes skin itching, etc. To mediate insect epidemics, particularly mosquitoes that are also liable to cause deadly diseases such as malaria and encephalitis, the use of electronic mosquito insect elimination, electric heating devices or sprays as a way to prevent such a distress are available. However, there is no significant effect for such strategies in open spaces, such as outdoors.

The present invention relates to a pest repellent wrist or ankle band to protect the human body from the pests, such as mosquitoes, in particular insect repellents that are prepared so as to comprise the wrist or ankle band material impregnated with repellents in a way to avoid the release of the active substance during the production process until the final use thereof, so as to prevent losses and to maintain the initial efficacy thereof.

The present invention protects exposed skin from harmful pests, for example mosquitoes, flies, bees and bugs. Plant essential oils, chemical pest repellent repellents and natural insect repellent ingredients, which are incorporated in the constituent material of the wrist or ankle band, are released in a controlled and effective way so as to achieve the desired goal.

The present invention may provide that the layer of repellent is arranged such that the repellent is deposited on the wrist or ankle band material when the wrist or ankle band is moved frictionally against the skin of the user. The body temperature allows the impregnated repellent to volatilize and, thus, protect the user, although said repellent layer is not in direct contact with the skin.

The present invention may provide that the layer of repellent is printed onto the wrist or ankle band material or is otherwise incorporated therein.

The present invention provides a method of manufacturing a repellent wrist or ankle band for repelling harmful insect pests, the method comprising conveying a wrist or ankle band material along a path and applying a layer of repellent to the said material.

The present invention may provide for drying the impregnated wrist or ankle band material as a finishing step.

The present invention may provide that the layer of repellent is applied substantially parallel to the path.

Applying the layer of repellent substantially parallel to the path has the advantage that the alignment of the wrist or ankle band as it is conveyed is simplified.

### BRIEF DESCRIPTION OF THE DRAWINGS

So that the present invention may he more fully understood embodiments will now be described by way of example only, with reference to the accompanying drawings in which:

FIG. 1 is a view of the repellent wrist or ankle band,

FIG. 2 is a view of a second embodiment of the repellent wrist or ankle band according to the present invention,

FIG. 3 is a view of a third embodiment of the repellent wrist or ankle band according to the present invention,

FIG. 4 is a perspective view of the repellent wrist or ankle band,

FIG. 5 is a perspective view of a second embodiment of the repellent wrist or ankle band according to the present invention, and

FIG. 6 is a perspective view of a third embodiment of the repellent wrist or ankle band according to the present invention.

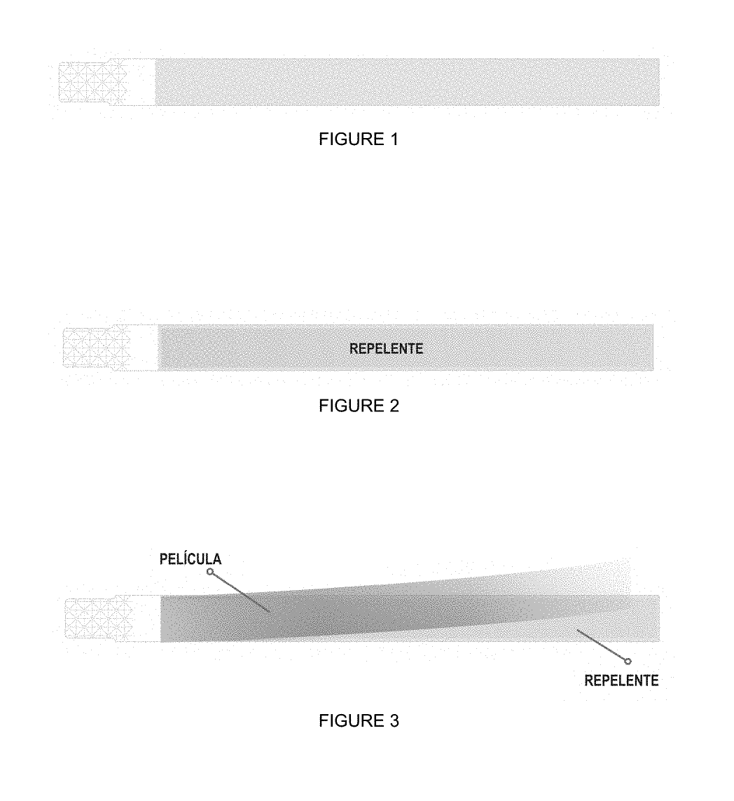

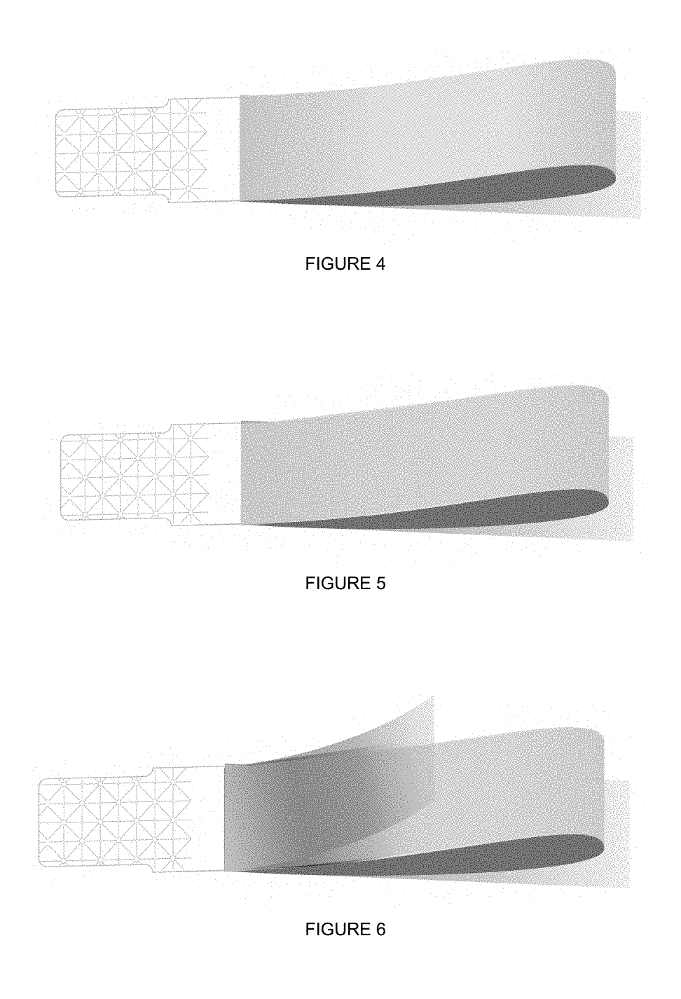

### DETAILED DESCRIPTION OF THE INVENTION

As used herein, the term “repellent” and the like refer to materials which, where local laws and regulations permit, may he used to create a desired aroma in a product, so that it is able to repel insects.

The natural insect repellent component used in the present invention can be used without particular limitation so long as it is insect repellent effect derived from natural products, preferably has a volatile profile. Examples of the natural insect repellent ingredient are, for example, an essential oil plant, patchouli oil, peppermint oil, peppermint oil, cypress oil, pine oil, perilla oil, catnip oil, fern-wood oil, lavender oil, coriander oil, eucalyptus oil, citronella oil, lime oil, lemon grass oil, neroli oil, Hiba oil, thyme oil, hyssop oil, rosemary oil, rose oil, ylang-ylang oil, pepper oil, cinnamon oil, camphor oil, Laurel oil, chamomile oil, wormwood oil, tarragon oil, clove oil, bay-leaf oil, geranium oil, sage oil, basil oil, parsley oil, star anise oil, fennel oil, manuka oil, galbanum oil, dill oil, violet oil, angelica oil, turmeric oil, ginger oil, ambrette oil, wintergreen oil, and the like. Examples of synthetic insect repellent ingredient are, for example, N,N′-diethyl-3-methylbenzamide (DEET), p-menthane-3,8-diol, 2-undecanone, 1-piperidinecarboxylic acid 2-(2-hydroxyethyl)-1-methylpropylester and ethyl butylacetylaminopropionate (IR 3535). These may be used alone or in combination.

The target pest in the present invention include, for example, the following: Diptera pests such as Culex, Culex pipiens, Aedes such as Aedes albopictus, Aedes aegypti, Anopheles such as Anopheles sinensis, midges such as housefly, little house fly, blowfly such, fleshflies, Tanebae, anthomyiidae such as onion maggot, fruit fly kind such as Drosophila, flies such as Abu class, black flies such as biting kind, biting midges, etc.

As a constituent material of the wrist or ankle bands, naturally occurring materials, such as cotton, as well as rayon, synthetic resins such as synthetic fibers and polyurethanes such as polyester as well as flashspun high-density polyethylene fibers may be used.

Regarding the addition of a natural insect repellent ingredient to the resin and/or fiber, the natural insect repellent ingredient is to be impregnated into the main component of the resin and/or fibers so as to create a high concentration in the final product.

As a method for coating a natural insect repellent ingredient on the surface of the constituent material of the wrist or ankle bands, in order to achieve a consistent spread along the material of the said wrist or ankle band, a spreading agent emulsion of the insect repellent component with a flowable agent may be applied after the wrist or ankle band is produced, or an adhesive layer of the natural insect repellent ingredient may be applied onto the surface of the constituent material of the wrist or ankle bands.

Regarding the addition of the natural insect repellent component onto the constituent material of the wrist or ankle bands it varies usually around 0.005 to 10 wt %, preferably 0.05 to 5 wt % of the final product. However, other repellent concentrations apparent to those skilled in the art may he used.

### EXAMPLES

Next, an illustrative example of the present invention is provided, but the present invention is not to be limited to this illustrative example.

A sheet comprising 10 units os Tyvek 1056 wrist or ankle bands with a grammage of 56 grams, wherein each wrist or ankle band has 24.5 cm in length and 2 cm of width was coated with a 10% solution of lavender oil so as to render, as a final product, a repellent wrist or ankle band.

Modifications to the described embodiment may he made without departing from the scope of the invention which is defined by the claims listed hereinafter.

1. A repellent wrist or ankle band, the wrist or ankle band having a layer of repellent arranged to be in contact with the wrist or ankle band material.

2. A wrist or ankle band according to claim 1, wherein the layer of added repellent is arranged such that the repellent is deposited onto the skin when the wrist or ankle band is moved frictionally against the skin of the user.

3. A wrist or ankle band according to claim 1, wherein the layer of the repellent is printed onto the wrist or ankle band material.

4. A wrist or ankle band according to claim 1, wherein the layer of the repellent is adhesively placed onto the wrist or ankle band material.

5. A wrist or ankle band according to claim 4, further comprising a tear strip to facilitate release of the repellent.

6. A wrist or ankle band according to claim 5, wherein the layer of repellent comprises a patch entered about the tear strip.

7. A wrist or ankle band according to claim 5, wherein the layer of repellent comprises a patch disposed below the tear strip.

8. A wrist or ankle band according to claim 1, wherein the tear strip is formed from mono-oriented polypropylene.

9. A wrist or ankle band according to claim 1, wherein it is made from flashspun high-density polyethylene fibers.

10. A wrist or ankle band according to claim 1, wherein the repellent is one of patchouli oil, peppermint oil, peppermint oil, cypress oil, pine oil, perilla oil, catnip oil, fern-wood oil, lavender oil, coriander oil, eucalyptus oil, citronella oil, lime oil, lemon grass oil, neroli oil, thyme oil, hyssop oil, rosemary oil, rose oil, ylang-ylang oil, pepper oil, cinnamon oil, camphor oil, Laurel oil, chamomile oil, wormwood oil, tarragon oil, clove oil, bay-leaf oil, geranium oil, sage oil, basil oil, parsley oil, star anise oil, fennel oil, manuka oil, galbanum oil, dill oil, violet oil, angelica oil, turmeric oil, ginger oil, ambrette oil, wintergreen oil, N,N′-diethyl-3-methylbenzamide, p-menthane-3,8-diol, 2-undecanone, 1-piperidinecarboxylic acid 2-(2-hydroxyethyl)-1-methylpropylester, ethyl butylacetylaminopropionate, or combinations thereof.
